(19) United States
(12) Patent Application Publication
(10) Pub. No.: US 2021/0216770 A1
(43) Pub. Date: Jul. 15, 2021

(54) METHOD AND SYSTEM FOR SMART LIVING SAFETY RESPONSE FROM CONTROL CENTER AND SAVIOR IN VIEW OF FACILITY AND INDUSTRIAL SAFETY BASED ON EXTENDED REALITY AND INTERNET OF THING

(71) Applicant: FRONTIS CORP., Suwon-si (KR)

(72) Inventor: Jin Suk KANG, Suwon-si (KR)

(73) Assignee: FRONTIS CORP., Suwon-si (KR)

(21) Appl. No.: 17/121,997

(22) Filed: Dec. 15, 2020

(30) Foreign Application Priority Data
Jan. 13, 2020 (KR) 10-2020-0004360

(51) Int. Cl. G06K 9/00; G06K 9/62; G06T 11/00; H04L 29/08; G16Y 20/10; H04L 12/66; G01C 21/20

(52) U.S. Cl. CPC G06K 9/00671; G06K 9/6217; G06T 11/00; G01C 21/20; G16Y 20/10; H04L 12/66; H04L 67/12

(57) ABSTRACT

A method for providing content responding to a living safety situation is provided such that a method for providing scene response content by a control center server to monitor a living safety situation includes: receiving situation information about a target area from an IoT sensor installed in the target area and an image of the target area from an HMD device deployed to the target area; inputting the image and the situation information into a scenario model previously trained on a method for responding to the living safety situation and analyzing an emergency situation of the living safety situation in the target area; creating scene response content which guides a response plan to the analyzed emergency situation by integrating geographical information about the structure of the target area with the image and the situation information; and transmitting the created scene response content to the HMD device.

### CROSS-REFERENCE TO RELATED APPLICATION

This application claims the benefit under 35 USC 119(a) of Korean Patent Application No. 10-2020-0004360 filed on Jan. 13, 2020, in the Korean Intellectual Property Office, the entire disclosures of which are incorporated herein by reference for all purposes.

### TECHNICAL FIELD

The present disclosure relates to a method and system for providing content responding to living safety based on extended reality, and more particularly, to a method and system for providing content for effective smart living safety response by more specifically analyzing a living safety situation using IoT sensor information and extended reality-integrated information, providing a response plan to the analyzed situation and providing extended reality-based content with improved immersion from the perspectives of a control center and a savior to a head mounted display (HMD) device.

Disasters described herein can be classified into natural disasters and social disasters, and herein, the present disclosure relates to effective preparation for safety situations as a response to living safety regarding industrial and facility safety as examples of the social disasters and proper plan and operation of proper safety management plan to respond to a threat in a systematic and scientific manner.

### BACKGROUND

Conventionally, as for a living safety response, virtual reality has provided virtual reality content for education to evacuate from a threatening situation or to suppress the threatening situation when such a situation happens. That is, the conventional virtual reality creates content responding to a threatening situation and provides the content to a user device, but cannot provide the content to a place where the threatening situation happens and can provide monotonous content to the user device deployed to the threatening situation. Therefore, the conventional virtual reality has not been substantially helpful in responding to or evacuating from the threatening situation.

In this regard, as a prior art, Korean Patent No. 10-1869254 entitled “System and method for analyzing evacuation routes when a fire occurs in a building based on virtual reality” discloses a technique that enables a more similar simulation to real fire accidents than conventional simulation tools to effectively provide help when disasters actually happen.

This patent is characterized based on cooperation and communication between a mater server and a slave server, i.e., two or more servers, to create virtual reality and augmented reality image data regarding living safety. However, this patent requires two or more servers, and, thus, it takes time and cost to perform communication between the servers, which results in a micro-delay while the created virtual reality image data are transmitted to a user device.

In particular, when a living safety threatening situation happens, the quality of communication with surroundings may deteriorate due to fire, smoke and shielding with a structure. Even in this case, when the two or more servers cooperate to create and transmit virtual reality image data, a delay in the creation process and a delay in the transmission process may overlap each other. Such a micro-time delay may affect the golden time for saving lives in an emergency situation. That is, the conventional virtual reality has not been substantially helpful for disaster situations.

Accordingly, there is a need for methods for providing content responding to smart living safety situations by creating extended reality-based content to be provided to a living safety threatening situation by means of a server with minimized time and effort to create the content and high immersion and providing substantial help to a scene.

### PRIOR ART DOCUMENT

Patent Document 1: Korean Patent No. 10-1869254 (registered on Jun. 14, 2018)

### SUMMARY

The technologies described and recited herein include a method for providing content responding to a living safety situation, by which a threat to living safety occurring in a target area can be detected using an IoT device and high-immersion extended reality-based content that guides a response plan to the detected threat can be provided to an HMD device.

Also, the technologies described and recited herein include a method for providing content responding to a living safety situation, by which scene response content can be created by using image and situation information about a target area where a threat to living safety occurs together with geographical information about the target area and thus content reflecting an emergency situation in real time with more reality and high immersion can be provided for responding to the scene.

However, the problems to be solved by the present disclosure are not limited to the above-described problems. Although not described herein, other problems to be solved by the present disclosure can be clearly understood by a person with ordinary skill in the art from the following descriptions.

In one example embodiment, a method for providing scene response content to be performed by a control center server that monitors a living safety situation includes: receiving situation information about a target area from an IoT sensor installed in the target area and an image of the target area from an HMD device deployed to the target area; inputting the image and the situation information into a scenario model previously trained on a method for responding to the living safety situation and analyzing an emergency situation of the living safety situation in the target area; creating scene response content which guides a response plan to the analyzed emergency situation by integrating geographical information about the structure of the target area, h the image and the situation information; and transmitting the created scene response content to the HMD device.

In an example embodiment, the analyzing the emergency situation includes: detecting the emergency situation based on the result of comparing the image and the situation information with emergency situations learned by the scenario model and analyzing an optimal response plan for the detected emergency situation by using result data about each response plan learned by the scenario model.

In an example embodiment, the analyzing the optimal response plan includes: monitoring the target area by using situation information received from the IoT sensor and including at least one of the temperature, humidity, illumination, motion, smoke, gas and vibration levels of the target area.

In an example embodiment, the analyzing the optimal response plan includes: determining an optimal route for evacuation from the emergency situation in the target area based on the location of the HMD device and the geographical information about the structure of the target area.

In an example embodiment, the determining the optimal route for evacuation from the emergency situation in the target area includes: renewing the optimal route that is determined by updating the emergency situation with the image and the situation information in real time.

In an example embodiment, the creating the scene response content includes: creating content in which an area where the emergency situation happens is displayed to be distinguished on a display of the HMD device.

In an example embodiment, the creating the scene response content includes: creating content in which the direction of an area where the emergency situation happens is displayed on a display of the HMD device.

In an example embodiment, the creating the scene response content includes: if it is determined that the structure of the target area is not visible due to the emergency situation as the result of analyzing the image taken by the HMD device, creating VR content and AR content that enable the HMD device to distinguish the structure of the target area by using the geographical information about the structure of the target area.

In an example embodiment, the creating the scene response content includes: if it is determined that the structure of the target area is visible in the presence of the emergency situation as the result of analyzing the image taken by the HMD device, creating AR content in which information that guides decision-making about the emergency situation is displayed to overlap on the structure of the target area.

In an example embodiment, the receiving the situation information about the target area includes: receiving the situation information from an ad-hoc network group formed adjacent to the HMD device equipped with a gateway.

In an example embodiment, the receiving the situation information about the target area further includes: receiving updated situation information from the ad-hoc network group that was formed adjacent to the HMD device and then reformed as the HMD device moves.

In another example embodiment, a control center server includes: a processor; a network interface; a memory that is implemented by the processor and loaded with a computer program; and a storage that stores the computer program. The computer program includes: an instruction to receive situation information about a target area from an IoT sensor installed in the target area and an image of the target area from an HMD device deployed to the target area; an instruction to input the image and the situation information into a scenario model previously trained on a method for responding to a living safety situation and analyze an emergency situation of the living safety situation in the target area; an instruction to create scene response content which guides a response plan to the analyzed emergency situation by integrating geographical information about the structure of the target area, the image and the situation information; and an instruction to transmit the created scene response content to the HMD device.

In yet another example embodiment, a method for outputting scene response content to be performed by an HMD device includes: transmitting an image of a target area where an emergency situation happens to a control center server that monitors the target area; receiving scene response content which guides a response plan to the emergency situation and is created by using geographical information about the image, the situation information and the structure of the target area; and displaying the received scene response content.

In an example embodiment, the displaying the scene response content includes: displaying an optimal route for evacuation from the emergency situation in the target area based on location information and the geographical information about the structure of the target area.

In an example embodiment, the displaying the scene response content includes: if it is determined that the structure of the target area is not visible in the image due to the emergency situation, displaying VR content that enables the structure of the target area to be distinguished.

In an example embodiment, the f displaying the scene response content includes: if it is determined that the structure of the target area included in the scene response content is visible in the presence of the emergency situation, displaying AR content in which information that guides decision-making about the emergency situation is output to overlap on the structure of the target area.

In an example embodiment, The method for outputting scene response content further includes: forming an ad-hoc network group with an IoT sensor or another HMD device adjacent to the HMD device within a predetermined range by using a gateway installed in the HMD device; collecting situation information about the target area from the IoT sensor or the HMD device within the network group; and transmitting the collected situation information to the control center server.

In an example embodiment, the forming the ad-hoc network group includes: reforming the ad-hoc network group as the IoT sensor or the HMD device adjacent to the HMD device within the predetermined range changes by movement.

According to any one of the above-described embodiments of the present disclosure, a method and system for providing content responding to a living safety situation can more specifically analyze the living safety situation using IoT sensor information and extended reality-integrated information and provide an HMD device with extended reality-based content with high immersion that guides a response plan to the analyzed living safety situation.

According to any one of the above-described embodiments of the present disclosure, a method and system for providing content responding to a living safety situation can create scene response content by using image and situation information about a target area where an emergency situation happens together with geographical information about the target area and thus provide content reflecting an emergency situation in real time with more reality and high immersion for responding to the scene.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 illustrates a schematic diagram of a system for providing content responding to a living safety situation, in accordance with various embodiments described herein.

FIG. 2 is a flowchart showing a method for providing scene response content, in accordance with various embodiments described herein.

FIG. 3 is a diagram for explaining a procedure in which data created by an IoT sensor are processed by a control center server, in accordance with various embodiments described herein.

FIG. 4 is an example depiction to explain that a control center outputs images of real-world scenes.

FIG. 5 is a diagram for explaining a method for detecting an area where a threatening situation happens from the images output by the control center.

FIG. 6 is a flowchart for specifically explaining a process S130 of FIG. 2.

FIG. 7 is an example depiction of geographical information about a target area to be used for creating scene response content.

FIG. 8 is a diagram for explaining scene response content to be output on an HMD device, in accordance with various embodiments described herein.

FIG. 9 is a diagram for explaining content for displaying markers to distinguish the structure of a target area.

FIG. 10 is a diagram for explaining a state where an HMD device forms a network group with objects adjacent to the HMD device.

FIG. 11 is a diagram for explaining a state where the network group of FIG. 10 is reformed as the HMD device moves.

FIG. 12 is a flowchart showing a method for outputting content responding to a living safety situation, in accordance with various embodiments described herein.

FIG. 13 is a flowchart for specifically explaining a process S250 of FIG. 12.

FIG. 14 is a flowchart showing a system for providing content responding to a living safety situation, in accordance with various embodiments described herein.

FIG. 15 illustrates the configuration of hardware for providing content responding to a living safety situation, in accordance with various embodiments described herein.

### DETAILED DESCRIPTION

Hereinafter, some embodiments of the present disclosure will be described in detail with reference to the accompanying drawings. The advantages and features of the present disclosure, and methods for accomplishing the same will be more clearly understood from embodiments described below with reference to the accompanying drawings. However, a technical concept of the present disclosure is not limited to the following embodiments but may be implemented in various different forms. The embodiments are provided only to complete the technical concept of the present disclosure and to fully provide a person with ordinary skill in the art to which the present disclosure pertains with the category of the invention, and the technical concept of the present disclosure will be defined by the appended claims.

When reference numerals refer to components of each drawing, although the same components are illustrated in different drawings, the same components are referred to by the same reference numerals as possible. Further, if it is considered that description of related known configuration or function may cloud the gist of the present disclosure, the description thereof will be omitted.

Unless otherwise defined, all terms including technical and scientific terms used herein have the same meaning as commonly understood by a person with ordinary skill in the art to which this invention belongs. It will be further understood that terms, such as those defined in commonly used dictionaries, should not be interpreted in an idealized or overly formal sense unless expressly so defined herein. The terms used herein are provided only for illustration of the exemplary embodiments but not intended to limit the present disclosure. As used herein, the singular terms include the plural reference unless the context clearly indicates otherwise.

Further, in describing components of the present disclosure, terms such as first, second, A, B, (a), (b), etc. can be used. These terms are used only to differentiate the components from other components. Therefore, the nature, order, sequence, etc. of the corresponding components are not limited by these terms. It is to be understood that when one element is referred to as being “connected to” or “coupled to” another element, it may be directly connected or coupled to another element or be connected or coupled to another element, having still another element “connected” or “coupled” therebetween.

The terms “comprises” and/or “comprising” specify the presence of stated components, steps, operations, and/or elements, but do not preclude the presence or addition of one or more other components, steps, operations, and/or elements.

Hereinafter, the embodiments of the present disclosure will be described in detail with reference to the accompanying drawings.

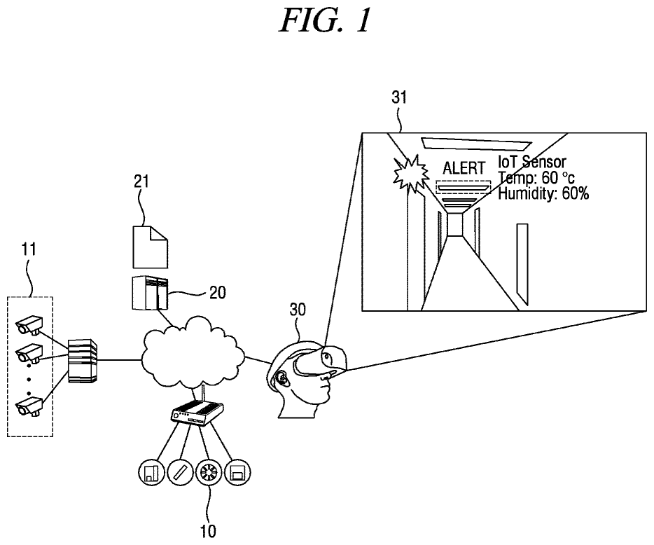

FIG. 1 illustrates a schematic diagram of a system for providing content responding to a living safety situation, in accordance with various embodiments described herein.

Referring to FIG. 1, the system for providing content responding to a living safety situation may include a control center server 20 and a head mounted display (HMD) device 30. The term “emergency situation” or “threatening situation” used herein includes an accident and a disaster, but may not be limited thereto, and may refer to various danger-possible situations such as risky events and symptoms.

The control center server 20 may create scene response content 31 responding to a living safety situation that happens in a target area and provide the scene response content to the HMD device 30. Herein, the target area refers to a place where an emergency situation happens and may refer to various areas, such as the inside and outside of a building and an outdoor area, where a living safety situation happens.

The control center server 20 may receive situation information from an IoT sensor 10 and a real-world image of the target area from the HMD device 30. The control center server 20 may input the received situation information into a scenario model 21 to analyze a living safety situation. The control center server 20 may use the result of analysis to create the scene response content 31 based on the type of living safety situation and the degree of damage. Here, the control center server 20 may create the scene response content 31 by integrating the image received from the HMD with geographical information about the structure of the target area. The control center server 20 may transmit the created scene response content 31 to the HMD device 30.

The HMD device 30 is a device deployed to the target area and may receive the scene response content 31 from the control center server 20 and output the scene response content 31 on the display. The structure and operating method of the HMD device 30 are already known in the art. Therefore, a detailed description thereof will be omitted. The term “HMD device 30” used herein is not limited to the HMD device 30 itself, but can be changed to various devices that can receive the scene response content 31 from the control center server 20 and output the scene response content 31 on the display.

The IoT sensor 10 may be installed in the target area to detect a situation in the target area and may create situation information using the result of detection. The IoT sensor 10 may transmit the created situation information directly to the control center server 20 or transmit the created situation information to the control center server 20 through a gateway that manages communication in a group of the IoT sensors 10. The IoT sensor 10 may include a closed-circuit television (CCTV) 11, and an image taken by the CCTV 11 may also be transmitted, as situation information, to the control center server 20. The IoT sensor 10 may be installed and fixed at the target area or may be temporarily deployed as a mobile sensor, but may not be limited thereto.

The system for providing content responding to a living safety situation according to an embodiment of the present disclosure creates the scene response content 31 using the real-world image and situation information of the target area where a threatening situation happens and the geographical information about the target area and thus can provide the scene response content 31 reflecting an emergency situation in real time with more reality and high immersion.

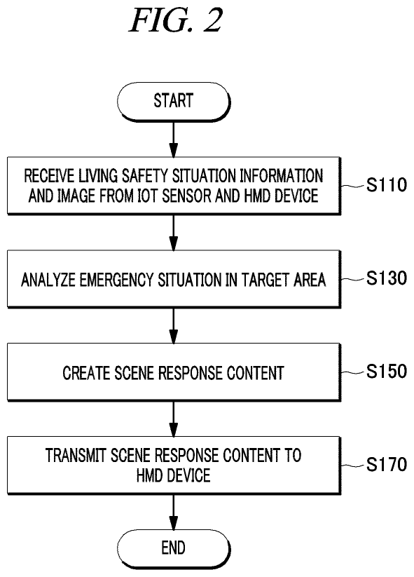

FIG. 2 is a flowchart showing a method for providing scene response content, in accordance with various embodiments described herein.

Referring to FIG. 2, in a process S110, situation information may be received from the IoT sensor 10 and a real-world image may be received from the HMD device 30. In an embodiment, the situation information including at least one of the temperature, humidity, illumination, motion, smoke, gas and vibration levels of the target area may be received from the IoT sensor 10. Here, the control center server 20 may receive, from the HMD device 30, an image of the target area taken by an imaging device coupled to the HMD device 30. In the present process, the situation information or the image may be received simultaneously or sequentially, but the sequence is not limited.

In a process S130, the image and the situation information may be input into the scenario model 21 to analyze a living safety situation in the target area. The scenario model 21 is a model that was previously trained on a method for responding to a living safety situation and may be created through machine learning of various living safety situations. In the present process, when the image and the situation information are input into the scenario model 21, the type of a living safety situation most similar to the input image and situation information, damage information and a response plan may be analyzed.

In a process S150, scene response content that guides a response plan to the living safety situation may be created. The response plan to the living safety situation may be a method or decision-making behavioral approach for evacuating from an emergency situation or for suppressing the occurrence of an emergency situation. When the scene response content is created, the scene response content may include a guide to a hint that enables a user watching the scene response content to easily implement the response plan or follow the output content. For example, the scene response content may include the output of the location of a fire hydrant for putting out flames during a fire on the display or an exit route for evacuation from the fire. Further, in the present process, the scene response content may be created by integrating the geographical information and the situation information about the target area.

In a process S170, the created scene response content may be transmitted to the HMD device 30. The scene response content is created by continuously reflecting information which is changed by receiving situation information and real-world images in real time, and, thus, the scene response content updated by changes in the emergency situation may be transmitted to the HMD device 30 in real time.

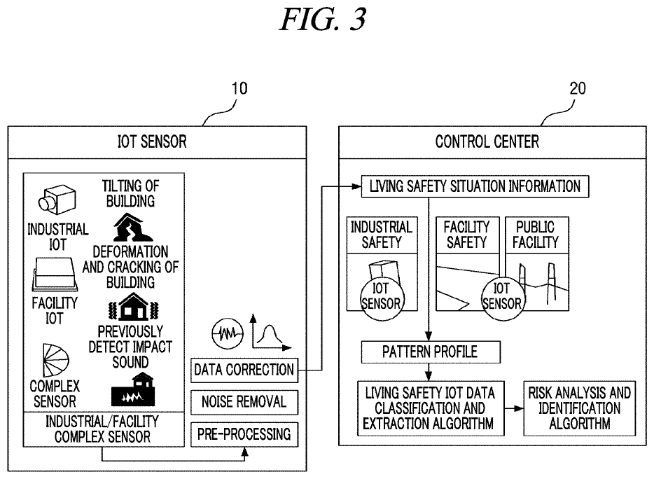

FIG. 3 is a diagram for explaining a procedure in which data created by the IoT sensor 10 are processed by the control center server 20, in accordance with various embodiments described herein.

Referring to FIG. 3, the situation information created by the IoT sensor 10 may be subjected to pre-processing and then transmitted to a control center. Specifically, the IoT sensor 10 may be composed of an industrial safety IoT, a facility safety IoT and a complex sensor, and the industrial safety IoT may create situation information about tilting of a building, the facility safety IoT may create situation information about structure deformation and cracking of the building, and the complex sensor may create situation information about impact sound. Situation information created by an industrial facility complex sensor is structured through pre-processing according to a predetermined protocol, noise is removed from the situation information through noise filtering and data are corrected to an appropriate range. The pre-processed situation information may be transmitted to the control center server 20, and the control center server 20 may reflect the received situation information to the scenario model 21 and analyze a pattern depending on the type of data. Then, the control center server 20 may use the analyzed pattern to analyze the type of the living safety situation and the degree of damage.

In a method for providing content responding to a living safety situation according to an embodiment of the present disclosure, the IoT sensor 10 is used to more specifically understand an emergency situation to accurately determine the type of the emergency situation and the degree of damage, and, thus, content appropriately responding to a living safety situation can be created.

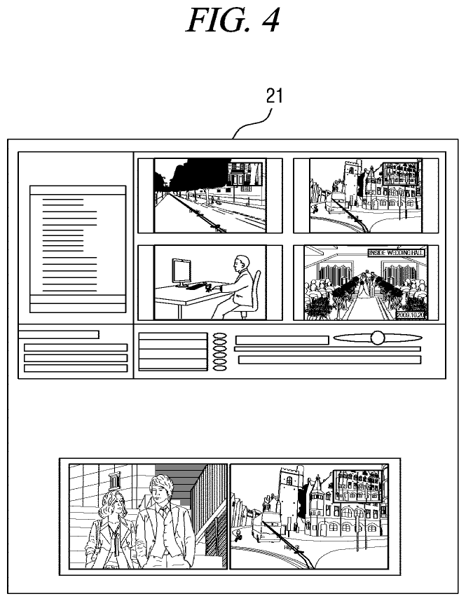

FIG. 4 is an example depiction to explain that a control center outputs images of real-world scenes.

Referring to FIG. 4, the control center server 20 may output the received image through a display device. The control center server 20 may output, through the display, the image received from the IoT sensor 10, the image received from the CCTV 11 or the image received from the HMD device 30. The control center server 20 may simultaneously output all or some of the received augmented images on the display to provide an image that enables monitoring of the living safety situation in the target area.

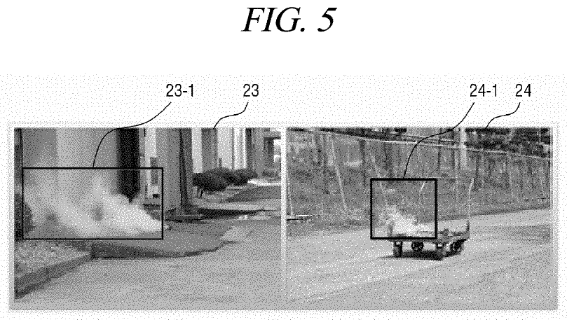

FIG. 5 is a diagram for explaining a method for detecting an area where a threatening situation happens from the images output by the control center.

Referring to FIG. 5, when a danger is detected from the image output by the control center, the scenario model 21 may detect a risk element and determine the current situation as a threatening situation. Here, the risk element in the threatening situation may be distinguished with a marker and a non-marker. When a risk element, such as smoke on the road, is detected from an image 23 or 24 of FIG. 5, the control center server 20 may overlap a marker and a non-marker 23-1 or 24-1 to distinguish the risk element on the image.

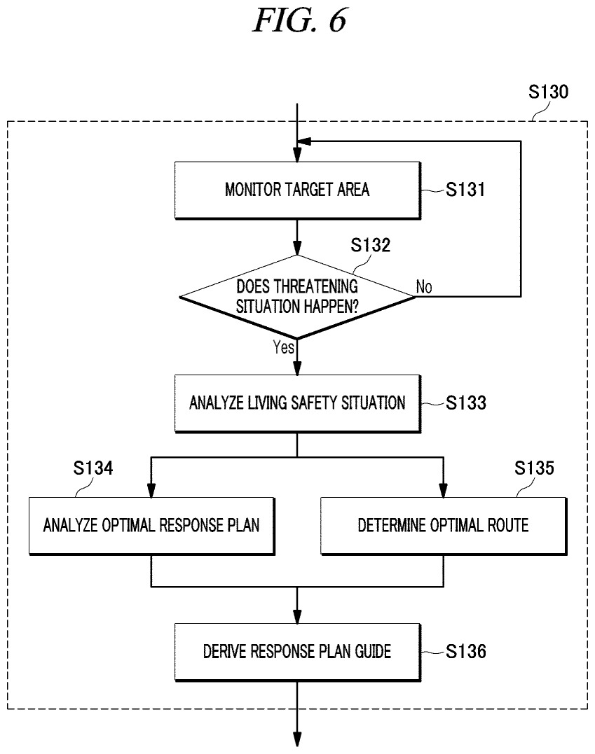

FIG. 6 is a flowchart for specifically explaining the process S130 of FIG. 2.

Referring to FIG. 6, while the threatening situation in the target area is analyzed, the target area may be monitored using the situation information and the image in a process S131. While the target area is monitored, if it is determined that a threatening situation happens in the target area based on the result of comparing the image and the situation information with emergency and threatening situations learned by the scenario model 21 in a process S132, the scenario model 21 may specifically analyze the living safety situation by determining whether the threatening situation is a fire, an earthquake, a traffic accident or an electric shock accident and may analyze whether or not the situation is dangerous and the degree of damage based on the degree of spread and continuity of the situation and the intensity of a sensor in a process S133. In a process S134, result data about each response plan learned by the scenario model 21 may be used to analyze an optimal response plan for the detected living safety situation.

In a process S135, an optimal route for evacuation from the living safety situation in the target area may be determined based on the location of the HMD device 30 and the geographical information about the structure of the target area. Here, the optimal route may be determined by updating threatening situation information in real time with images and situation information. Further, the optimal route may be renewed with updated information by updating the living safety situation with images and situation information in real time.

In a process S136, a response plan guide may be derived using the optimal response plan and the optimal route. For example, the response plan guide may be content that guides a user to move to the location of a fire hydrant, operate the fire hydrant and evacuate from the target area along an optima route as an optimal response plan for an emergency situation such as a fire.

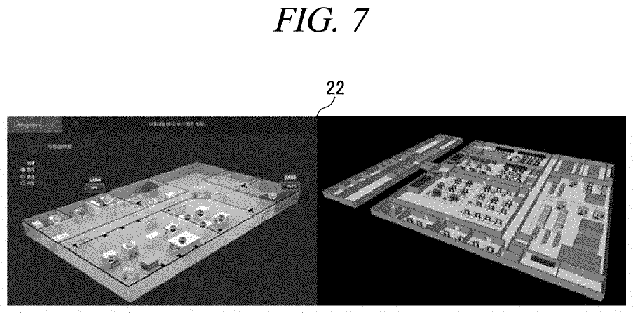

FIG. 7 is an example depiction of geographical information about a target area to be used for creating scene response content.

Referring to FIG. 7, geographical information 22 about the target area may be a three-dimensional drawing of the target area. The geographical information 22 may be data provided form a public office or data previously input into the control center server 20. The control center server 20 may previously analyze the structure of the target area based on the geographical information 22 to render the scene response content to be similar to the real world.

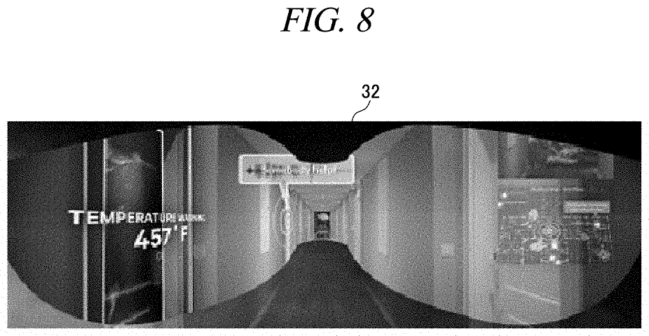

FIG. 8 is a diagram for explaining scene response content to be output on the HMD device 30, in accordance with various embodiments described herein.

Referring to FIG. 8, the control center server 20 may create content including information that guides the structure of the target area and the response plan to the living safety situation. The control center server 20 may create content such that situation information created by the IoT sensor 10 and a living safety situation can be visually distinguished on the content. In scene response content 32 of FIG. 8, an IoT sensor detects and displays the temperature of the left side of a hallway, and a dangerous area in the middle of the hallway is visibly displayed, and the current location of the HMD device 30 is displayed on the right side by using the geographical information. In another embodiment, the control center server 20 may create content in which the direction of an area where an emergency situation happens is displayed on the display of the HMD device 30.

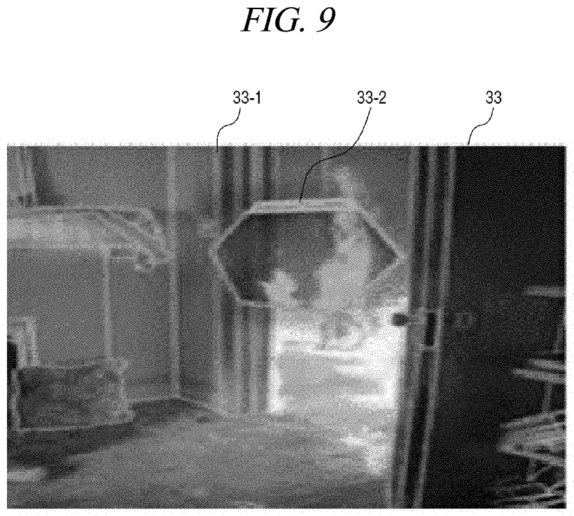

FIG. 9 is a diagram for explaining content for displaying markers and non-markers to distinguish the structure of a target area.

If the control center server 20 determines that the structure of the target area is not visible due to the living safety situation as the result of analyzing the real world image taken by the HMD device 30, the control center server 20 may create virtual reality (VR) content and augmented reality (AR) content that enable the HMD device 30 to distinguish the structure of the target area by using the geographical information about the structure of the target area. In another embodiment, if the control center server 20 determines that the structure of the target area is visible in the presence of the living safety situation as the result of analyzing the real world image taken by the HMD device 30, the control center server 20 may create AR content in which information that guides decision-making about the threatening situation is displayed to overlap on the structure of the target area.

Accordingly, in the method for providing content responding to a living safety situation according to an embodiment of the present disclosure, content is appropriately modified depending on the current situation of the HMD device 30 deployed to the living safety situation and then provided. Thus, even when the HMD device 30 cannot distinguish the structure of the target area due to the threatening situation, it is possible to easily distinguish the structure of the target area.

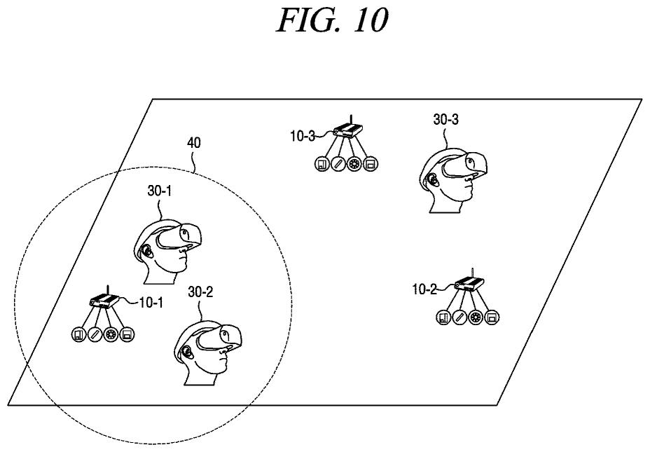

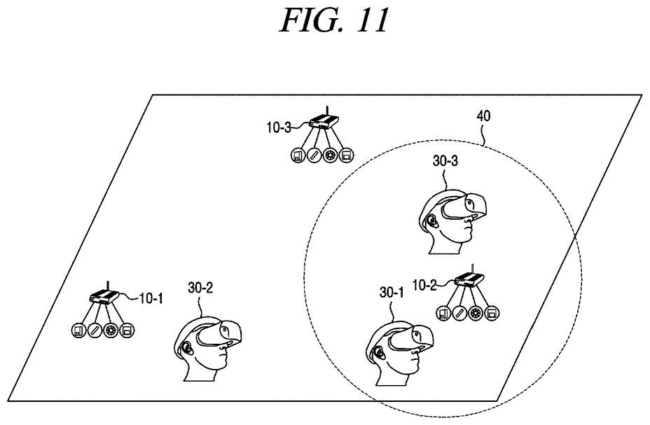

FIG. 10 is a diagram for explaining a state where the HMD device 30 forms a network group with objects adjacent to the HMD device 30, and FIG. 11 is a diagram for explaining a state where the network group of FIG. 10 is reformed as the HMD device 30 moves.

Referring to FIG. 10, the HMD device 30 may receive situation information from an ad-hoc network group formed adjacent to the HMD device 30 equipped with a gateway. The HMD device 30 is equipped with a gateway such as a router to form an ad-hoc network group with its adjacent object, i.e., another HMD device 30 or the IoT sensor 10, and thus can directly transmit and receive information.

As shown in FIG. 10, an IoT sensor 10-1 and an HMD device 30-2 adjacent to an HMD device 30-1 may form an ad-hoc network group.

Further, referring to FIG. 11, the ad-hoc network group formed adjacent to the HMD device 30 may be reformed as the HMD device 30 moves, and updated situation information can be received from the reformed ad-hoc network group. The ad-hoc network group shown in FIG. 10 may be reformed with an IoT sensor 10-2 and an HMD device 30-3 adjacent to the HMD device 30-1 as the HMD device 30-1 moves as shown in FIG. 11.

In this case, in the method for providing content responding to a living safety situation according to the present disclosure, even when the quality of communication deteriorates and information cannot be transmitted and received due to a living safety situation as an ad-hoc network group is formed, it is possible to efficiently respond to the living safety situation by using information shared within the network group.

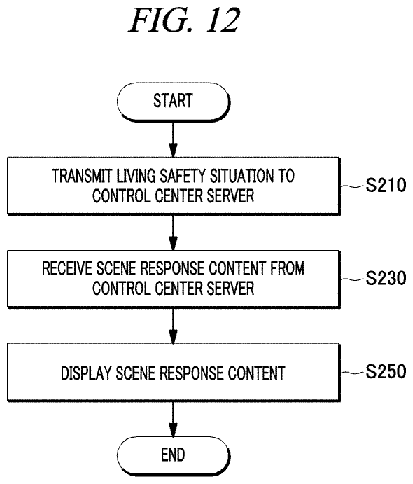

FIG. 12 is a flowchart showing a method for outputting content responding to a living safety situation, in accordance with various embodiments described herein.

Referring to FIG. 12, in a process S210, a real-world image of a target area where an emergency situation happens may be transmitted to the control center server 20 that monitors the situation, and in a process S230, scene response content that guides a response plan to a living safety situation created using location information about the real world and geographical information about the structure of the target area may be received from the control center server 20, and in a process S250, the scene response content may be displayed.

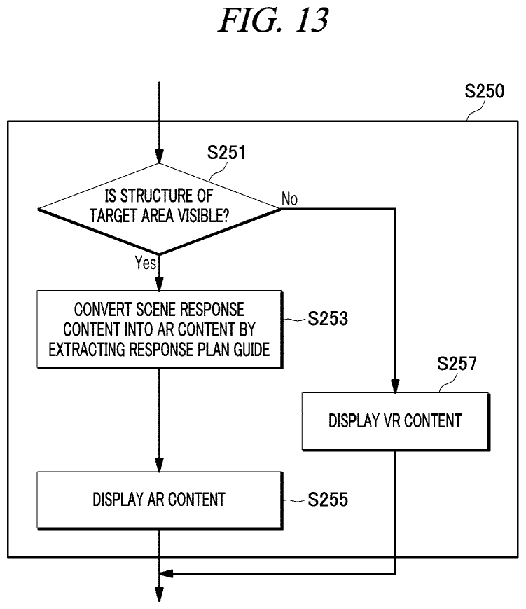

FIG. 13 is a flowchart for specifically explaining the process S250 of FIG. 12.

Referring to FIG. 13, when the scene response content is displayed, it is determined in a process S251 whether the structure of the target area can be distinguished. If it is determined that the structure of the target area can be distinguished, the scene response content may be converted into AR content by extracting a response plan guide in a process S253. According to an embodiment, when the scene response content is received from the control center server 20, it can be received in a form that can be converted into AR content in which the response plan guide is mainly output and VR content in which the response plan guide or the structure of the target area is displayed. When a user wearing the HMD device 30 cannot distinguish the structure of the target area, the HMD device 30 may convert the scene response content into VR content and output the VR content to provide the user with information about the structure of the target area. In an embodiment, if the HMD device 30 determines that the structure of the target area can be appropriately distinguished and the VR content makes it difficult for the user to distinguish the structure of the target area, the HMD device 30 may convert the scene response content into AR content and output the AR content.

Accordingly, in the method for providing content responding to a living safety situation according to another embodiment of the present disclosure, extended reality content is appropriately used, and, thus, it is possible to more efficiently respond to an emergency situation.

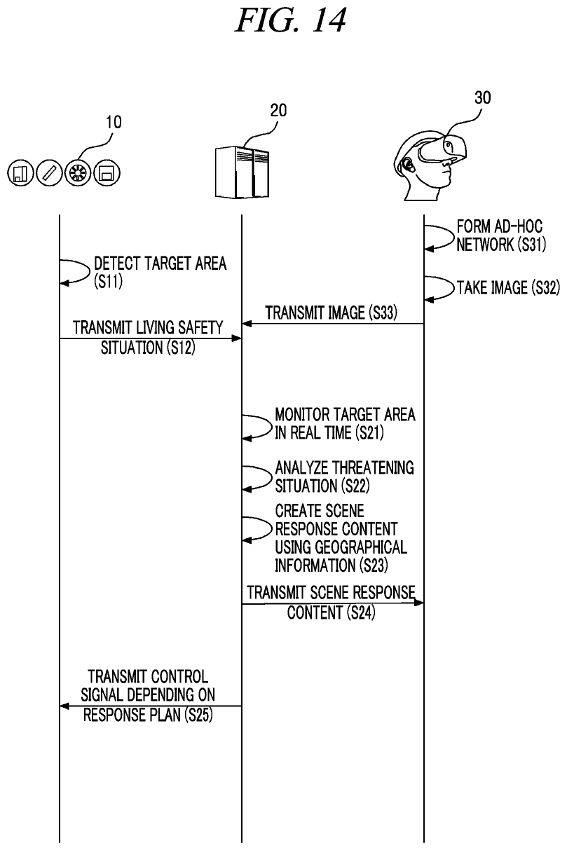

FIG. 14 is a flowchart showing a system for providing content responding to a living safety situation, in accordance with various embodiments described herein.

Referring to FIG. 14, in a process S11, the IoT sensor 10 may detect the target area and create situation information about the target area. In a process S12, the IoT sensor 10 may transmit living safety situation information to the control center server 20. The HMD device 30 may an ad-hoc network with its adjacent object to collect situation information in a process S31, monitor situations of the target area in a process S32 and transmit the information to the control center server 20 in a process S33.

In a process S21, the control center server 20 may perform real-time monitoring to the target area based on the received information. If a risk element is detected during the monitoring in a process S22, the control center server 20 may analyze the risk element. In a process S23, the control center server 20 may create scene response content using geographical information about the target area. In a process S24, the created scene response content may be provided to the HMD device 30. According to another embodiment, in a process S25, the control center server 20 may transmit a control signal depending on a response plan to the IoT sensor 10.

The control center server 20 of the system for providing content responding to a living safety situation according to an embodiment of the present disclosure may include a receiving unit that receives situation information about a living safety situation in a target area from an IoT sensor installed in the target area and an image of the target area from an HMD device deployed to the target area, a living safety situation analyzing unit that inputs the image and the situation information into a scenario model previously trained on a method for responding to the living safety situation and analyzes a situation of the target area, a scene response content creating unit that creates scene response content which guides a response plan to an emergency situation by using the image, the situation information and geographical information about the structure of the target area, and a scene response content transmitting unit that transmits the created scene response content to the HMD device 30 deployed to the target area.

The HMD device 30 may include an image providing unit that transmits a real-world image of the target area where an emergency situation happens to the control center server 20, a content receiving unit that receives the scene response content, and a display unit that displays the received scene response content.

The methods according to the embodiments described above can be performed by the execution of a computer program implemented as computer-readable code. The computer program may be transmitted from a first computing device to a second computing device through a network such as the Internet and may be installed in the second computing device and thus used in the second computing device. Examples of the first computing device and the second computing device include fixed computing devices such as a server, a physical server belonging to a server pool, and a desktop PC.

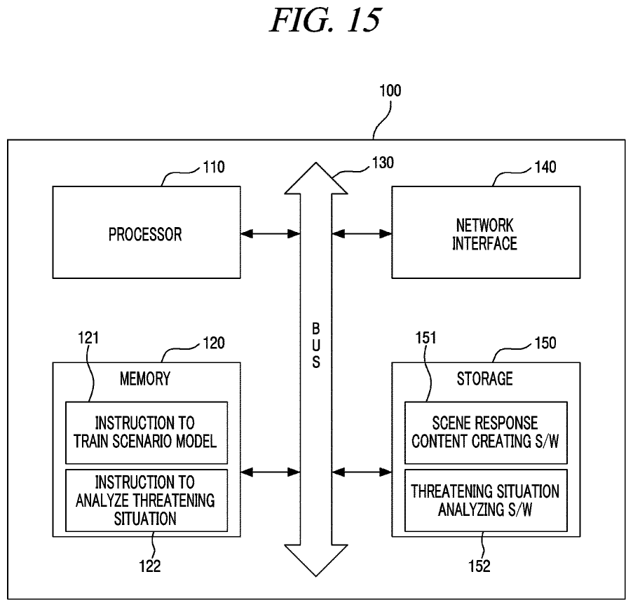

The computer program may be stored in a recording medium such as a DVD-ROM or a flash memory. Hereinafter, the hardware configuration of a control center server 100 according to yet another embodiment of the present disclosure will be described with reference to FIG. 15.

Referring to FIG. 15, the control center server 100 according to yet another embodiment of the present disclosure may include one or more processors 110, a memory 120 that is loaded with a scene response content creating program 151 and an emergency situation analyzing program 152 to be executed by the processors 110, a bus 130, a network interface 140 and a storage 150 that stores the scene response content creating program 151 and the emergency situation analyzing program 152. Here, FIG. 15 illustrates only the components relevant to the embodiments of the present disclosure. Therefore, a person with ordinary skill in the art can understand that other universal components may be further included in addition to the components shown in FIG. 15.

The processor 110 controls the overall operation of each component of the control center server 100. The processor 110 may be configured to include a central processing unit (CPU), a micro processing unit (MPU), a graphic processing unit (GPU) or any type of processor well known in the art. Also, the processor 110 may perform the operation of at least one application or program for performing the method according to the embodiments of the present disclosure. Here, the control center server 100 illustrated in FIG. 15 is illustrated as including one processor 110, but may not be limited thereto and may include a plurality of processors.

The memory 120 stores various types of data, commands, and/or information. The memory 120 may be loaded with the scene response content creating program 151 and the emergency situation analyzing program 152 from the storage 150 in order to perform the method/operation according to various embodiments of the present disclosure. When the memory 120 is loaded with the scene response content creating program 151 and the emergency situation analyzing program 152, the processor 110 may execute one or more instructions 121 and 122 composing the scene response content creating program 151 and the emergency situation analyzing program 152 to perform the method/operation for providing content responding to a living safety situation. The memory 120 may be implemented as a volatile memory such as a RAM, but the technical scope of the present disclosure is not limited thereto.

The bus 130 provides a communication function between the constituent components of the control center server 100. The bus 130 may be implemented as various forms of bus such as an address bus, a data bus and a control bus.

The network interface 140 supports wired/wireless Internet communication of the control center server 100. Also, the network interface 140 may support various communication methods other than the Internet communication. To this end, the network interface 140 may be configured to include a communication module well known in the art. In an embodiment, the network interface 140 may be omitted.

The storage 150 may temporarily or non-temporarily store the scene response content creating program 151 and the emergency situation analyzing program 152. If an application program is executed and operated by the control center server 100, the storage 150 may store various data on the executed application program. For example, the storage 150 may store information about the executed application program, operation information about the application program and information about a user who requests the execution of the application program.

The storage 150 may be configured to include a non-volatile memory such as a ROM (Read Only Memory), an EPROM (Erasable Programmable ROM), an EEPROM (Electrically Erasable Programmable ROM), and flash memory, a hard disk, a removable disk, or any type of computer-readable recording medium well known in the art.

When loaded into the memory 120, the scene response content creating program 151 and the emergency situation analyzing program 152 may include one or more instructions 121 and 122 that allow the processor 110 to perform the method/operation according to various embodiments of the present disclosure. That is, the processor 110 can perform the method/operation according to various embodiments of the present disclosure by executing the one or more instructions 121 and 122.

In an embodiment, the scene response content creating program 151 and the emergency situation analyzing program 152 may include an instruction to receive situation information about a target area from an IoT sensor installed in the target area and an image of the target area from an HMD device deployed to the target area, an instruction to input the image and the situation information into a scenario model previously trained on the method for responding to the living safety situation and analyze the living safety situation of the target area, an instruction to create scene response content which guides a response plan to the analyzed living safety situation by integrating geographical information about the structure of the target area with the image and the situation information, and an instruction to transmit the created scene response content to the HMD device.

Various embodiments of the present disclosure and the effects of the embodiments have been described above with reference to FIG. 1 to FIG. 15. The effects to be achieved by the present disclosure are not limited to the above-described effects. Although not described herein, other effects to be achieved by the present disclosure can be clearly understood by a person with ordinary skill in the art from the following description.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure.

We claim:

1. A method for providing scene response content to be performed by a control center server that monitors a living safety situation, comprising:
receiving situation information about a target area from an IoT sensor installed in the target area and an image of the target area from an HMD device deployed to the target area;
inputting the image and the situation information into a scenario model previously trained on a method for responding to the living safety situation and analyzing an emergency situation of the living safety situation in the target area;
creating scene response content which guides a response plan to the analyzed emergency situation by integrating geographical information about the structure of the target area, the image and the situation information; and
transmitting the created scene response content to the HMD device.

2. The method for providing scene response content of claim 1,
wherein the analyzing the emergency situation includes:
detecting the emergency situation based on the result of comparing the image and the situation information with emergency situations learned by the scenario model and analyzing an optimal response plan for the detected emergency situation by using result data about each response plan learned by the scenario model.

3. The method for providing scene response content of claim 2,
wherein the analyzing the optimal response plan includes:
monitoring the target area by using situation information received from the IoT sensor and including at least one of the temperature, humidity, illumination, motion, smoke, gas and vibration levels of the target area.

4. The method for providing scene response content of claim 2,
wherein the analyzing the optimal response plan includes:
determining an optimal route for evacuation from the emergency situation in the target area based on the location of the HMD device and the geographical information about the structure of the target area.

5. The method for providing scene response content of claim 4,
wherein the determining the optimal route for evacuation from the emergency situation in the target area includes:
renewing the optimal route that is determined by updating the emergency situation with the image and the situation information in real time.

6. The method for providing scene response content of claim 1,
wherein the creating the scene response content includes:
creating content in which an area where the emergency situation happens is displayed to be distinguished on a display of the HMD device.

7. The method for providing scene response content of claim 1,
wherein the creating the scene response content includes:
creating content in which the direction of an area where the emergency situation happens is displayed on a display of the HMD device.

8. The method for providing scene response content of claim 1,
wherein the creating the scene response content includes:
if it is determined that the structure of the target area is not visible due to the emergency situation as the result of analyzing the image taken by the HMD device, creating VR content and AR content that enable the HMD device to distinguish the structure of the target area by using the geographical information about the structure of the target area.

9. The method for providing scene response content of claim 1,
wherein the creating the scene response content includes:
if it is determined that the structure of the target area is visible in the presence of the emergency situation as the result of analyzing the image taken by the HMD device, creating AR content in which information that guides decision-making about the emergency situation is displayed to overlap on the structure of the target area.

10. The method for providing scene response content of claim 1,
wherein the receiving the situation information about the target area includes:
receiving the situation information from an ad-hoc network group formed adjacent to the HMD device equipped with a gateway.

11. The method for providing scene response content of claim 10,
wherein the receiving the situation information about the target area further includes:
receiving updated situation information from the ad-hoc network group that was formed adjacent to the HMD device and then reformed as the HMD device moves.

12. A control center server, comprising:
a processor;
a network interface;
a memory that is implemented by the processor and loaded with a computer program; and
a storage that stores the computer program,
wherein the computer program includes:
an instruction to receive situation information about a target area from an IoT sensor installed in the target area and an image of the target area from an HMD device deployed to the target area;
an instruction to input the image and the situation information into a scenario model previously trained on a method for responding to a living safety situation and analyze an emergency situation of the living safety situation in the target area;
an instruction to create scene response content which guides a response plan to the analyzed emergency situation by integrating geographical information about the structure of the target area, the image and the situation information; and
an instruction to transmit the created scene response content to the HMD device.

13. A method for outputting scene response content to be performed by an HMD device, comprising:
transmitting an image of a target area where an emergency situation happens to a control center server that monitors the target area;
receiving scene response content which guides a response plan to the emergency situation and is created by using geographical information about the image, the situation information and the structure of the target area; and
displaying the received scene response content.

14. The method for outputting scene response content of claim 13,
wherein the displaying the scene response content includes:
displaying an optimal route for evacuation from the emergency situation in the target area based on location information and the geographical information about the structure of the target area.

15. The method for outputting scene response content of claim 13,
wherein the displaying the scene response content includes:
if it is determined that the structure of the target area is not visible in the image due to the emergency situation, displaying VR content that enables the structure of the target area to be distinguished.

16. The method for outputting scene response content of claim 13,
wherein the displaying the scene response content includes:
if it is determined that the structure of the target area included in the scene response content is visible in the presence of the emergency situation, displaying AR content in which information that guides decision-making about the emergency situation is output to overlap on the structure of the target area.

17. The method for outputting scene response content of claim 13, further comprising:
forming an ad-hoc network group with an IoT sensor or another HMD device adjacent to the HMD device within a predetermined range by using a gateway installed in the HMD device;
collecting situation information about the target area from the IoT sensor or the HMD device within the network group; and
transmitting the collected situation information to the control center server.

18. The method for outputting scene response content of claim 17,
wherein the forming the ad-hoc network group includes:
reforming the ad-hoc network group as the IoT sensor or the HMD device adjacent to the HMD device within the predetermined range changes by movement.
